(19) United States
(12) Patent Application Publication
(10) Pub. No.: US 2024/0187504 A1
(43) Pub. Date: Jun. 6, 2024

(54) COMMUNICATION SYSTEM, RETRANSMISSION CONTROL METHOD, RECEIVING SIDE DEVICE, AND SENDING SIDE DEVICE

(71) Applicant: NIPPON TELEGRAPH AND TELEPHONE CORPORATION, Tokyo (JP)

(72) Inventors: Hisayoshi KANO, Musashino-shi, Tokyo (JP); Hiroki SHIBAYAMA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 18/284,537

(22) PCT Filed: Apr. 2, 2021
(86) PCT No.: PCT/JP2021/014389

§ 371 Date: Sep. 28, 2023

(51) Int. Cl. H04L 69/163; H04L 47/193

(52) U.S. Cl. CPC H04L 69/163; H04L 47/193

(57) ABSTRACT

A communication system performs communication on the basis of a TCP. The communication system includes a transmission-side device and a reception-side device. A route switching time zone is a time zone in which a communication route between the transmission-side device and the reception-side device is switched from a first communication route to a second communication route. When detecting packet missing of a first packet in the route switching time zone, the reception-side device prohibits transmission of a retransmission request related to the first packet to the transmission-side device during a first time from detection of the packet missing. When not receiving the first packet during the first time, the reception-side device transmits a retransmission request related to the first packet to the transmission-side device.

### TECHNICAL FIELD

The present invention relates to retransmission control in a communication system that performs communication on the basis of a transmission control protocol (TCP).

### BACKGROUND ART

In recent years, satellite communication networks have been used for various purposes. In order to perform appropriate communication control in such satellite communication, it is conceivable to use a highly reliable TCP. “Retransmission control” is known as one function of the TCP for ensuring communication reliability.

FIGS. 1 and 2 are conceptual diagrams for describing retransmission control in a TCP. A transmission side assigns a sequence number to a packet to be transmitted to a reception side. The reception side can detect (recognize) “missing” of the packet by checking the sequence number of the packet received from the transmission side. Such “missing” of the packet is called “packet missing” or “packet loss”.

In the description below, a packet with sequence number i is referred to as a “packet i” for the sake of simplicity. In the example illustrated in FIGS. 1 and 2, the reception side receives packet N+1 and subsequent packets in a state where a packet N has not yet been received. Thus, the reception side detects the packet missing of the packet N. When detecting the packet missing, the reception side transmits a “retransmission request” for requesting retransmission of the packet N to the transmission side.

The transmission side receives the retransmission request related to the packet N from the reception side. When the retransmission request related to the same packet N is received three times, the transmission side retransmits the packet N to the reception side. Alternatively, when an acknowledgement response (hereinafter referred to as “ACK”) related to the packet N is not received within a predetermined retransmission timeout after transmission of the packet N, the transmission side retransmits the packet N to the reception side. In the example illustrated in FIG. 1, the transmission side retransmits the packet N to the reception side after receiving the retransmission request related to the same packet N three times.

In the example illustrated in FIG. 2, a change in packet arrival order occurs, and the packet N arrives at the reception side later than packets N+1 and N+2. When receiving the packet N, the reception side transmits an ACK indicating a notification of reception of the packet N to the transmission side. The transmission side receives the ACK related to the packet N before receiving the retransmission request related to the packet N three times. Therefore, the transmission side determines that retransmission of the packet N is unnecessary.

When receiving the ACK for the transmission packet, the TCP increases the number of transmission packets. On the other hand, when packet retransmission occurs, the TCP reduces the number of transmission packets to avoid congestion in a network. Therefore, in a high delay environment with a large round trip time (RTT) like a satellite communication network, the number of transmission packets does not easily increase, and the throughput of the entire system decreases.

Non Patent Literature 1 discloses a retransmission control method of a TCP in a high delay environment. In the retransmission control method, a reduction amount of the number of transmission packets when packet retransmission occurs is flexibly set according to the environment. Specifically, in the case of the high delay environment, the reduction amount of the number of transmission packets is suppressed as compared with the case of the low delay environment.

### CITATION LIST

### Non Patent Literature

Non Patent Literature 1: Ikeda, Nishiyama, and Kato, “A Study of Retransmission Control of Transport Protocol Supported by Network Nodes in Wireless Networks with Long Delay”, IEICE Technical Report, SAT2010-28, July 2010.

### SUMMARY OF INVENTION

### Technical Problem

The inventor of the present application has recognized the problem described below regarding a situation in which a communication route between the transmission side and the reception side is switched. FIG. 3 illustrates a situation in which a communication route is switched between a transmission timing of the packet N and a transmission timing of the packet N+1. In particular, switching from a communication route with a large delay to a communication route with a small delay occurs. In this case, the packet N reaches the reception side significantly later than the packet N+1. However, the transmission side has already received the retransmission request related to the packet N three times, and retransmits the packet N to the reception side. Although it is late, since the reception side has received the original packet N, the retransmission of the packet N can be said to be “unnecessary retransmission”. Even when such unnecessary packet retransmission occurs, the TCP reduces the number of transmission packets. As a result, the throughput of the entire system decreases.

One object of the present invention is to provide a technology capable of suppressing a decrease in throughput of the entire system due to switching of a communication route in a communication system that performs communication on the basis of a TCP.

### Solution to Problem

A first aspect relates to a communication system that performs communication on the basis of a transmission control protocol (TCP).

The communication system includes a transmission-side device and a reception-side device.

A route switching time zone is a time zone in which a communication route between the transmission-side device and the reception-side device is switched from a first communication route to a second communication route.

When detecting packet missing of a first packet in the route switching time zone, the reception-side device prohibits transmission of a retransmission request related to the first packet to the transmission-side device during a first time from detection of the packet missing.

When not receiving the first packet during the first time, the reception-side device transmits a retransmission request related to the first packet to the transmission-side device.

A second aspect relates to a retransmission control method in the communication system that performs communication between the transmission-side device and the reception-side device on the basis of the TCP.

A route switching time zone is a time zone in which a communication route between the transmission-side device and the reception-side device is switched from a first communication route to a second communication route.

The retransmission control method includes processing of prohibiting transmission of a retransmission request related to the first packet from the reception-side device to the transmission-side device during the first time from detection of packet missing when the packet missing of the first packet is detected by the reception-side device in the route switching time zone.

The retransmission control method includes processing of transmitting a retransmission request related to the first packet from the reception-side device to the transmission-side device when the reception-side device has not received the first packet during the first time.

A third aspect relates to the reception-side device that performs communication with the transmission-side device on the basis of the TCP.

The reception-side device includes a controller that performs retransmission control.

A route switching time zone is a time zone in which a communication route between the transmission-side device and the reception-side device is switched from a first communication route to a second communication route.

When detecting packet missing of the first packet in the route switching time zone, the controller prohibits transmission of a retransmission request related to the first packet to the transmission-side device during the first time from detection of the packet missing.

When not receiving the first packet during the first time, the controller transmits a retransmission request related to the first packet to the transmission-side device.

A fourth aspect relates to the transmission-side device that performs communication with the reception-side device on the basis of the TCP.

The transmission-side device includes a controller that performs retransmission control.

A route switching time zone is a time zone in which a communication route between the transmission-side device and the reception-side device is switched from a first communication route to a second communication route.

The controller sets the retransmission timeout to be longer than a default value regarding a packet transmitted to the reception-side device in the route switching time zone.

### Advantageous Effects of Invention

According to the present invention, even when detecting packet missing in a route switching time zone, the reception-side device does not immediately transmit a retransmission request to the transmission-side device. Therefore, unnecessary packet retransmission due to switching of the communication route is suppressed. This makes it possible to suppress a decrease in throughput of the entire system.

### BRIEF DESCRIPTION OF DRAWINGS

FIG. 1 is a conceptual diagram for describing retransmission control in a TCP.

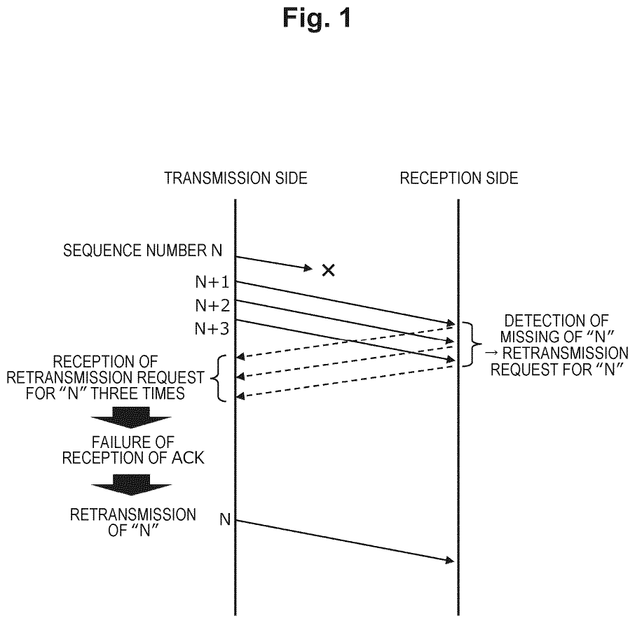

FIG. 2 is a conceptual diagram for describing retransmission control in a TCP.

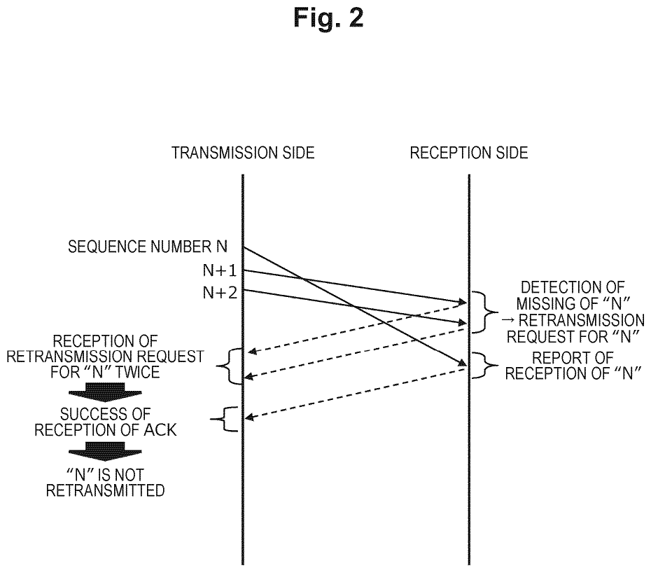

FIG. 3 is a conceptual diagram for describing a problem.

FIG. 4 is a block diagram schematically illustrating a configuration of a communication system according to an embodiment of the present invention.

FIG. 5 is a schematic diagram illustrating an example of a communication system according to an embodiment of the present invention.

FIG. 6 is a schematic diagram illustrating another example of a communication system according to an embodiment of the present invention.

FIG. 7 is a schematic diagram illustrating yet another example of a communication system according to an embodiment of the present invention.

FIG. 8 is a conceptual diagram for describing switching of a communication route according to an embodiment of the present invention.

FIG. 9 is a schematic diagram for describing an example of switching of a communication route according to an embodiment of the present invention.

FIG. 10 is a schematic diagram for describing another example of switching of a communication route according to an embodiment of the present invention.

FIG. 11 is a schematic diagram for describing yet another example of switching of a communication route according to an embodiment of the present invention.

FIG. 12 is a conceptual diagram for describing an outline of retransmission control according to an embodiment of the present invention.

FIG. 13 is a flowchart illustrating retransmission control in a transmission-side device according to an embodiment of the present invention.

FIG. 14 is a flowchart illustrating retransmission control in a reception-side device according to an embodiment of the present invention.

FIG. 15 is a conceptual diagram for describing a first modification of retransmission control according to an embodiment of the present invention.

FIG. 16 is a flowchart illustrating a second modification of retransmission control in a transmission-side device according to an embodiment of the present invention.

FIG. 17 is a flowchart illustrating a second modification of retransmission control in a reception-side device according to an embodiment of the present invention.

FIG. 18 is a block diagram illustrating a configuration example of each of a transmission-side device and a reception-side device according to an embodiment of the present invention.

FIG. 19 is a block diagram illustrating a configuration example of a controller of each of a transmission-side device and a reception-side device according to an embodiment of the present invention.

### DESCRIPTION OF EMBODIMENTS

An embodiment of the present invention will be described with reference to the accompanying drawings.

### 1. Communication System

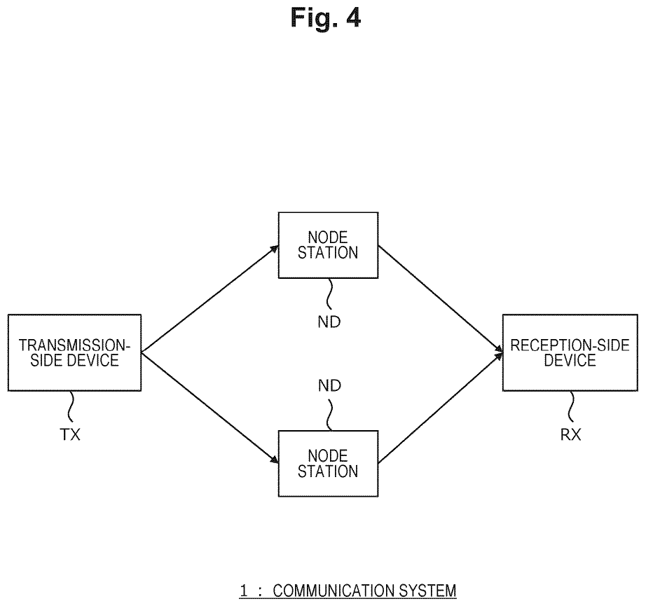

FIG. 4 is a block diagram schematically illustrating a configuration of a communication system 1 according to the present embodiment. The communication system 1 includes a transmission-side device TX, a reception-side device RX, and a plurality of node stations ND. The node station ND relays communication. The transmission-side device TX and the reception-side device RX communicate with each other via at least one node station ND. When the node station ND to pass through changes, a communication route between the transmission-side device TX and the reception-side device RX also changes. Note that the communication in the present embodiment also includes communication between the node stations ND. That is, the transmission-side device TX and the reception-side device RX are a concept including the node station ND.

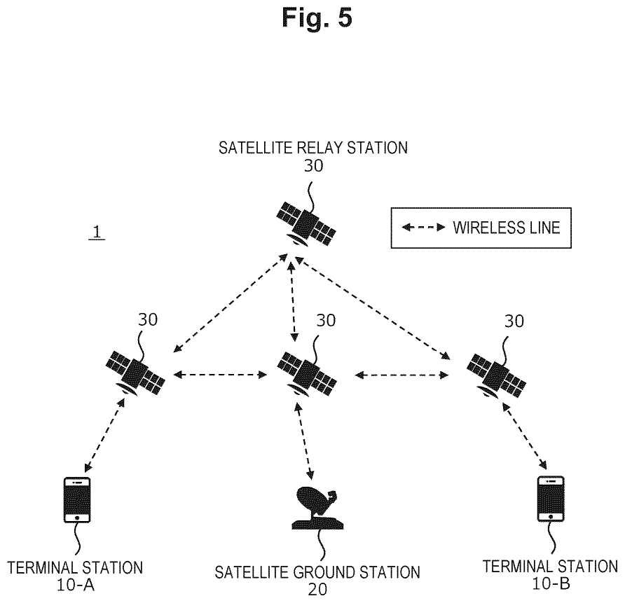

FIG. 5 is a schematic diagram illustrating an example of the communication system 1 according to the present embodiment. The communication system 1 includes a terminal station 10, a satellite ground station 20, and a plurality of satellite relay stations 30. Examples of the satellite relay station 30 include a geostationary satellite, a middle earth orbit satellite, a low earth orbit satellite, a high altitude pseudo satellite, and the like. Each satellite relay station 30 corresponds to the node station ND. A satellite communication network is constructed by establishing links between the plurality of satellite relay stations 30. A terminal station 10-A and a terminal station 10-B perform wireless communication with each other via at least one node station ND (satellite relay station 30). The satellite ground station 20 performs wireless communication with the terminal station 10-A or the terminal station 10-B via at least one node station ND (satellite relay station 30). Furthermore, communication may be performed between the satellite relay stations 30. The transmission-side device TX is any of the terminal station 10, the satellite ground station 20, and the satellite relay station 30. The reception-side device RX is any of the terminal station 10, the satellite ground station 20, and the satellite relay station 30.

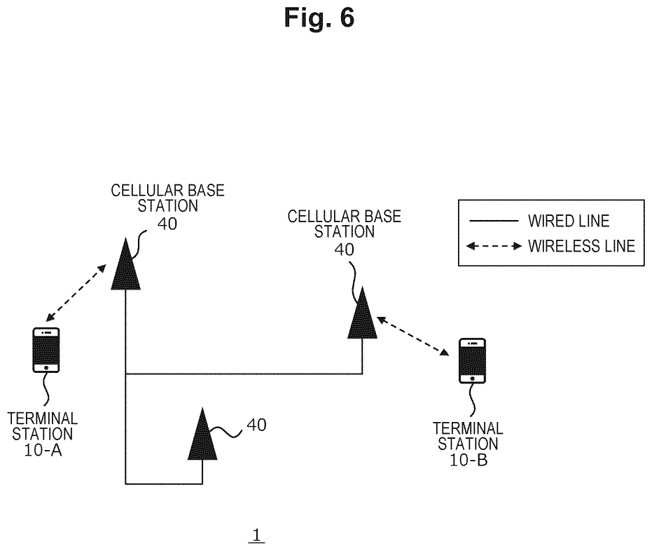

FIG. 6 is a schematic diagram illustrating another example of the communication system 1 according to the present embodiment. The communication system 1 includes the terminal station 10 and a plurality of cellular base stations 40. Each cellular base station 40 corresponds to the node station ND. The terminal station 10-A and the terminal station 10-B perform communication with each other via at least one node station ND (cellular base station 40). The transmission-side device TX is any of the terminal station 10 and the cellular base station 40. The reception-side device RX is any of the terminal station 10 and the cellular base station 40.

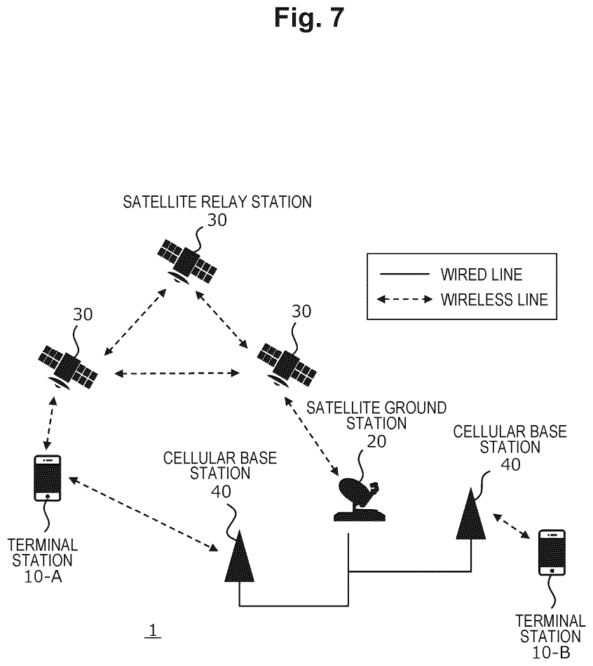

FIG. 7 is a schematic diagram illustrating yet another example of the communication system 1 according to the present embodiment. The communication system 1 includes the terminal station 10, the satellite ground station 20, the plurality of satellite relay stations 30, and the plurality of cellular base stations 40. Each satellite relay station 30 and each cellular base station 40 correspond to the node station ND. The terminal station 10-A and the terminal station 10-B perform communication with each other via at least one node station ND. The satellite ground station 20 performs communication with the terminal station 10-A or the terminal station 10-B via at least one node station ND. The transmission-side device TX is any of the terminal station 10, the satellite ground station 20, the satellite relay station 30, and the cellular base station 40. The reception-side device RX is any of the terminal station 10, the satellite ground station 20, the satellite relay station 30, and the cellular base station 40.

The communication system 1 according to the present embodiment performs communication on the basis of a TCP. That is, the transmission-side device TX and the reception-side device RX communicate with each other on the basis of a TCP. The transmission-side device TX assigns a sequence number to a packet to be transmitted to the reception-side device RX. Packet i represents a packet with sequence number i. When receiving the packet i, the reception-side device RX transmits an ACK (acknowledgement response) indicating a notification of reception of the packet i to the transmission-side device TX.

Furthermore, the reception-side device RX can detect (recognize) packet missing (packet loss) by checking the sequence number of the received packet. When detecting the packet missing of the packet i, the reception-side device RX transmits a “retransmission request” for requesting retransmission of the packet i to the transmission-side device TX. When the retransmission request related to the same packet i is received three times, the transmission-side device TX retransmits the packet i to the reception-side device RX. Alternatively, when an ACK related to the packet i is not received within a retransmission timeout after transmission of the packet i, the transmission-side device TX retransmits the packet i to the reception-side device RX.

### 2. Switching of Communication Route

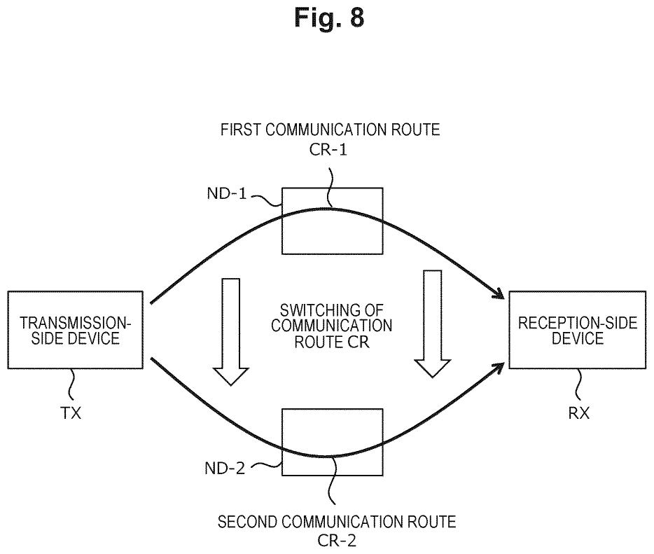

FIG. 8 is a conceptual diagram for describing switching of a communication route CR between the transmission-side device TX and the reception-side device RX. The communication route CR between the transmission-side device TX and the reception-side device RX is switched from a first communication route CR-1 to a second communication route CR-2. The first communication route CR-1 before switching passes through at least a node station ND-1. The second communication route CR-2 after switching passes through at least a node station ND-2 different from the node station ND-1. The first communication route CR-1 and the second communication route CR-2 passing through different node stations ND may have different delay. For example, the delay in the second communication route CR-2 is smaller than the delay in the first communication route CR-1.

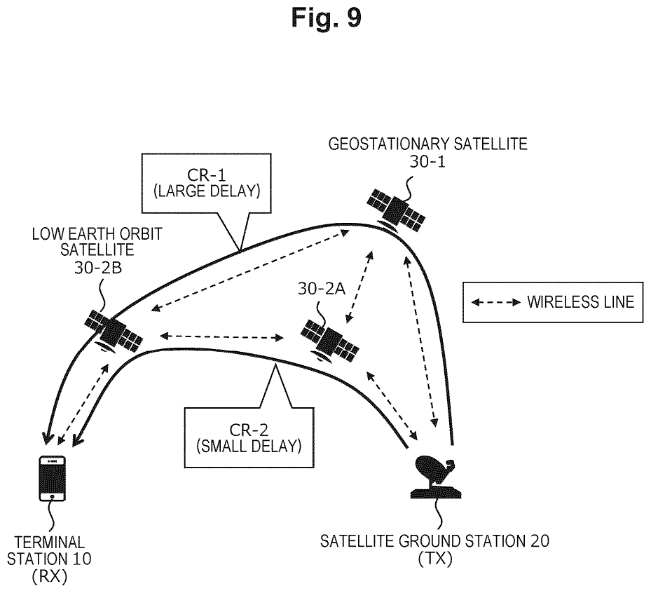

FIG. 9 is a schematic diagram for describing an example of switching of the communication route CR in the communication system 1 as illustrated in FIG. 5. In the example illustrated in FIG. 9, the satellite ground station 20 is the transmission-side device TX, and the terminal station 10 is the reception-side device RX. The satellite relay station 30, which is the node station ND, includes a geostationary satellite 30-1 and low earth orbit satellites 30-2A and 30-2B. The first communication route CR-1 passes through the geostationary satellite 30-1 and the low earth orbit satellite 30-2B. On the other hand, the second communication route CR-2 does not pass through the geostationary satellite 30-1, but passes through only the low earth orbit satellites 30-2A and 30-2B. The geostationary satellite 30-1 is present 36,000 km above the equator, whereas the low earth orbit satellites 30-2 are present at an altitude of 2,000 km or less. Therefore, the delay in the second communication route CR-2 is smaller than the delay in the first communication route CR-1.

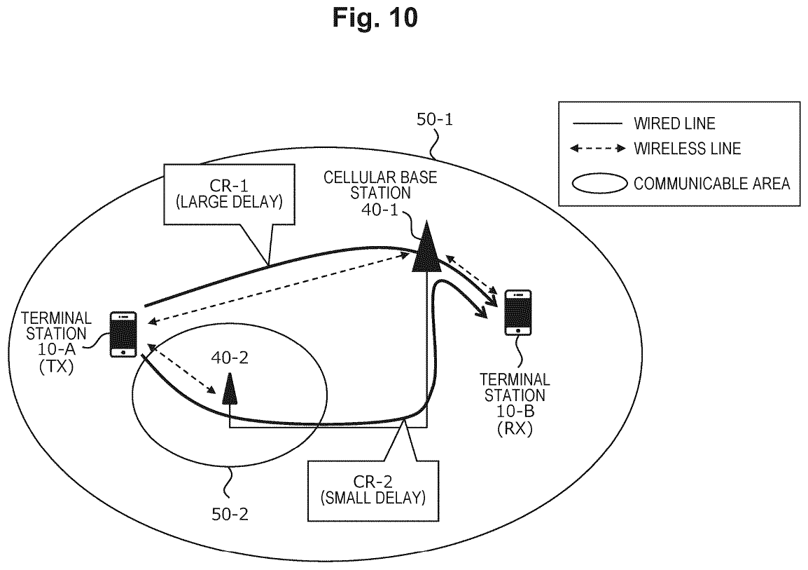

FIG. 10 is a schematic diagram for describing an example of switching of the communication route CR in the communication system 1 as illustrated in FIG. 6. In the example illustrated in FIG. 10, the terminal station 10-A is the transmission-side device TX, and the terminal station 10-B is the reception-side device RX. The cellular base station 40, which is the node station ND, includes a cellular base station 40-1 having a relatively large communicable area 50-1 and a cellular base station 40-2 having a relatively small communicable area 50-2. In the first communication route CR-1, the terminal station 10-A is directly connected to the far cellular base station 40-1. On the other hand, in the second communication route CR-2, the terminal station 10-A is connected to the close cellular base station 40-2, and the cellular base stations 40-1 and 40-2 are connected by wire. Therefore, the delay in the second communication route CR-2 is smaller than the delay in the first communication route CR-1.

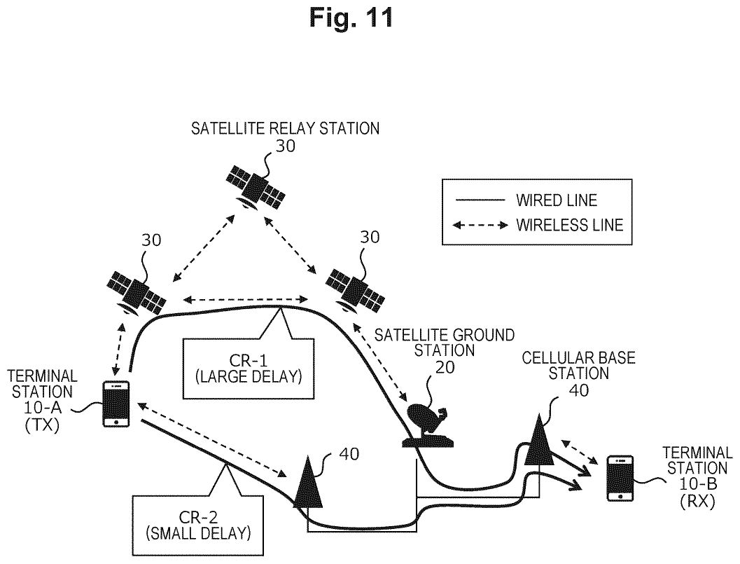

FIG. 11 is a schematic diagram for describing an example of switching of the communication route CR in the communication system 1 as illustrated in FIG. 7. In the example illustrated in FIG. 11, the terminal station 10-A is the transmission-side device TX, and the terminal station 10-B is the reception-side device RX. The first communication route CR-1 passes through the satellite relay station 30. On the other hand, the second communication route CR-2 does not pass through the satellite relay station 30, but passes through only the cellular base station 40. Therefore, the delay in the second communication route CR-2 is smaller than the delay in the first communication route CR-1.

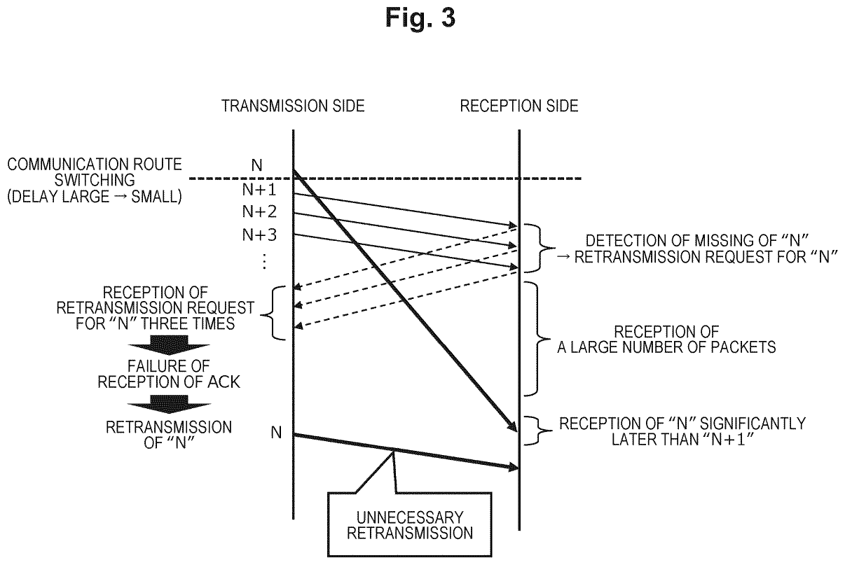

As described above, in a case where the delay in the second communication route CR-2 is smaller than the delay in the first communication route CR-1, the aforementioned problem as illustrated in FIG. 3 may occur. That is, unnecessary packet retransmission may occur due to switching of the communication route CR, and the throughput of the entire system may decrease. Therefore, the retransmission control according to the present embodiment is designed so that unnecessary packet retransmission due to switching of the communication route CR can be suppressed. Hereinafter, the retransmission control according to the present embodiment will be described in detail.

### 3. Retransmission Control

### 3-1. Outline

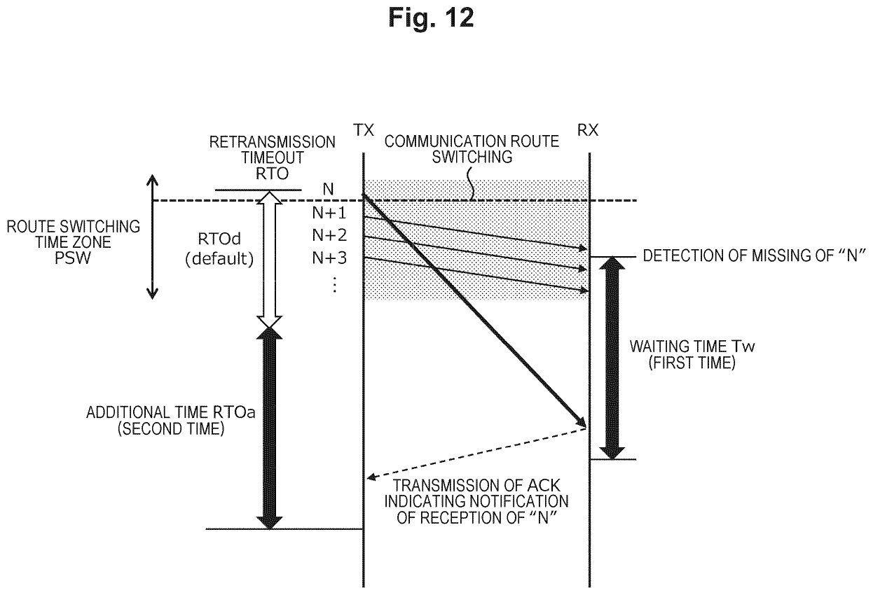

FIG. 12 is a conceptual diagram for describing an outline of retransmission control according to the present embodiment. The communication route CR is switched between a transmission timing of the packet N and a transmission timing of the packet N+1. The communication route CR at the time of transmission of the packet N is the first communication route CR-1 with high delay. The communication route CR at the time of transmission of the packet N+1 and subsequent packets is the second communication route CR-2 with low delay. Thus, the packet N reaches the reception-side device RX significantly later than the packet N+1.

A “route switching time zone PSW” is a time zone in which the communication route CR between the transmission-side device TX and the reception-side device RX is switched. More specifically, the route switching time zone PSW is a certain period including a timing at which the communication route CR is switched (route switching timing). For example, in a case where the node station ND includes the satellite relay station 30, the timing at which the communication route CR is switched can be predicted on the basis of the satellite orbit information of the satellite relay station 30. In this case, the route switching time zone PSW is a certain period including the predicted route switching timing. As another example, it is possible to sense the switching of the node station ND to pass through, that is, the switching of the communication route CR on the basis of handover information. In this case, the route switching time zone PSW is a certain period including the sensed route switching timing. The route switching time zone PSW may be a certain period after the sensed route switching timing.

The reception-side device RX detects packet missing of the packet N in the route switching time zone PSW. However, even when detecting the packet missing, the reception-side device RX does not immediately transmit the retransmission request related to the packet N. The reception-side device RX waits for the arrival of the packet N without transmitting the retransmission request until “waiting time Tw” elapses from detection of the packet missing. In other words, the reception-side device RX prohibits transmission of the retransmission request related to the packet N to the transmission-side device TX during the “waiting time Tw” from detection of the packet missing. When receiving the packet N during the waiting time Tw, the reception-side device RX transmits an ACK (acknowledgement response) indicating a notification of reception of the packet N to the transmission-side device TX. The reception-side device RX transmits a retransmission request related to the packet N to the transmission-side device TX only if the packet N is not received even after the waiting time Tw has elapsed.

As described above, according to the present embodiment, when detecting the packet missing of the packet N in the route switching time zone PSW, the reception-side device RX prohibits transmission of the retransmission request related to the packet N to the transmission-side device TX during the waiting time Tw from the detection of the packet missing. Thus, unnecessary transmission of the retransmission request until the reception-side device RX receives the packet N is suppressed. Therefore, the transmission-side device TX is prevented from receiving the retransmission request related to the packet N three times. As a result, the transmission-side device TX is prevented from unnecessarily retransmitting the packet N. That is, it is possible to suppress a decrease in the throughput of the entire system due to the switching of the communication route CR.

The transmission-side device TX may perform packet retransmission on the basis of a retransmission timeout RTO. Specifically, when an ACK related to the packet i is not received within the retransmission timeout RTO after transmission of the packet i, the transmission-side device TX retransmits the packet i to the reception-side device RX. In order to suppress unnecessary packet retransmission, the transmission-side device TX may set the retransmission timeout RTO to be longer regarding the packet N transmitted in the route switching time zone PSW. For example, the transmission-side device TX sets the retransmission timeout RTO regarding the packet N transmitted in the route switching time zone PSW as in Formula (1) below.

RTO=RTOd+RTOa Formula (1)

RTOd is a default value of the retransmission timeout RTO. Regarding a packet transmitted in a period other than the route switching time zone PSW, the retransmission timeout RTO is set to the default value RTOd. RTOa is an “additional time” added to the packet N transmitted in the route switching time zone PSW.

As described above, the transmission-side device TX may set the retransmission timeout RTO to be longer than the default value RTOd by the additional time RTOa regarding the packet N transmitted to the reception-side device RX in the route switching time zone PSW. Thus, the transmission-side device TX is further prevented from unnecessarily retransmitting the packet N. Therefore, it is possible to further suppress a decrease in the throughput of the entire system due to the switching of the communication route CR.

Note that the waiting time Tw in the reception-side device RX and the additional time RTOa in the transmission-side device TX may be predetermined values (constant values) or may be variable values. The waiting time Tw and the additional time RTOa may be the same or different. The waiting time Tw and the additional time RTOa may be set to the same value by the same method.

### 3-2. Processing Flow in Transmission-Side Device

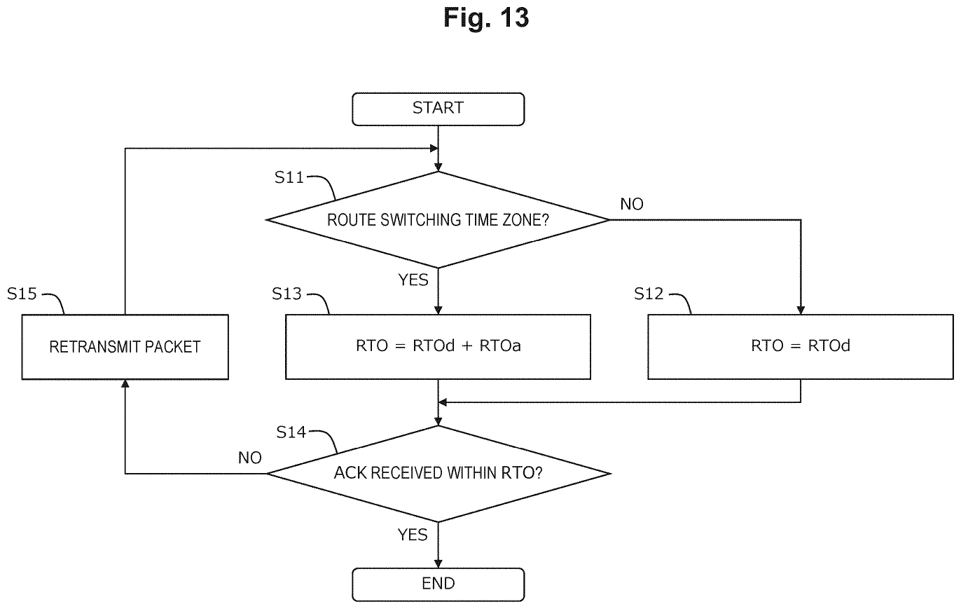

FIG. 13 is a flowchart illustrating retransmission control in the transmission-side device TX according to the present embodiment. Here, the packet i transmitted from the transmission-side device TX to the reception-side device RX is considered.

In step S11, the transmission-side device TX determines whether or not the packet i has been transmitted in the route switching time zone PSW. As described above, the route switching time zone PSW is a certain period including a timing at which the communication route CR is switched (route switching timing). For example, the transmission-side device TX predicts the route switching timing on the basis of the satellite orbit information of the satellite relay station 30, and grasps the route switching time zone PSW on the basis of the predicted route switching timing. The satellite orbit information is provided from the satellite relay station 30 or a satellite management system to the transmission-side device TX. As another example, the transmission-side device TX may sense the route switching timing on the basis of the handover information and grasp the route switching time zone PSW on the basis of the sensed route switching timing. The handover information is acquired by the transmission-side device TX or provided from another device.

When the packet i is not transmitted in the route switching time zone PSW (step S11; No), the processing proceeds to step S12. In step S12, the transmission-side device TX sets the retransmission timeout RTO related to the packet i to the default value RTOd (RTO=RTOd). Thereafter, the processing proceeds to step S14.

On the other hand, when the packet i is transmitted in the route switching time zone PSW (step S11; Yes), the processing proceeds to step S13. In step S13, the transmission-side device TX sets the retransmission timeout RTO related to the packet i to the sum of the default value RTOd and the additional time RTOa (RTO=RTOd+RTOa). Thereafter, the processing proceeds to step S14.

In step S14, the transmission-side device TX determines whether or not the ACK related to the packet i has been received within the retransmission timeout RTO after the transmission of the packet i. When the transmission-side device TX receives the ACK related to the packet i within the retransmission timeout RTO (step S14; Yes), the transmission processing related to the packet i ends.

On the other hand, when the transmission-side device TX has not received the ACK related to the packet i within the retransmission timeout RTO (step S14; No), the processing proceeds to step 315. In step S15, the transmission-side device TX retransmits the packet i to the reception-side device RX. Thereafter, the processing returns to step S11.

Note that, in step S11, it is not always necessary to determine the magnitude of the delay between the first communication route CR-1 and the second communication route CR-2. In a case where the first communication route CR-1 has a high delay and the second communication route CR-2 has a low delay, an effect that unnecessary packet retransmission is suppressed as described above can be obtained. On the other hand, in a case where the first communication route CR-1 has a low delay and the second communication route CR-2 has a high delay, a change in packet arrival order is unlikely to occur in the first place, and packet missing is also unlikely to occur. Therefore, the transmission-side device TX has a high probability of normally receiving the ACK, and is less likely to perform packet retransmission regardless of the setting of the retransmission timeout RTO.

### 3-3. Processing Flow in Reception-Side Device

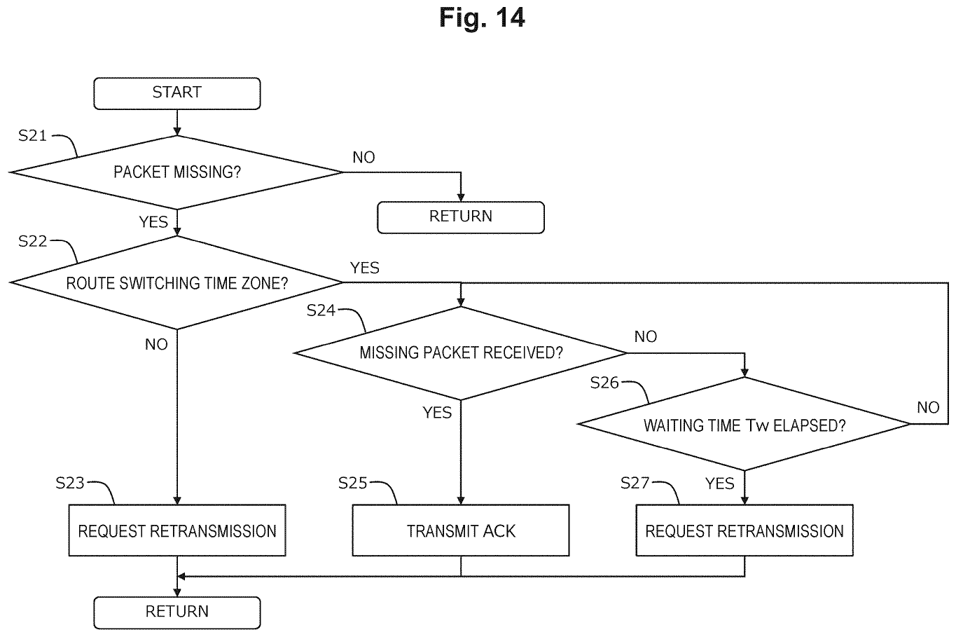

FIG. 14 is a flowchart illustrating retransmission control in the reception-side device RX according to the present embodiment.

In step S21, the reception-side device RX determines whether packet missing of a certain packet i has occurred. When no packet missing is detected (step S21; No), the processing in this cycle ends. On the other hand, when packet missing is sensed (step S21; Yes), the processing proceeds to step S22.

In step S22, the reception-side device RX determines whether or not the packet missing has occurred in the route switching time zone PSW. The method of acquiring the route switching time zone PSW is similar to the case of step S11 by the transmission-side device TX described above.

When the packet missing occurs when other than in the route switching time zone PSW (step S22; No), the processing proceeds to step S23. In step S23, the reception-side device RX transmits the retransmission request related to the packet i to the transmission-side device TX.

On the other hand, when the packet missing occurs in the route switching time zone PSW (step S22; Yes), the processing proceeds to step S24. In step S24, the reception-side device RX determines whether or not the missing packet i has been received.

When the packet i is received (step S24; Yes), the processing proceeds to step S25. In step S25, the reception-side device RX transmits an ACK indicating a notification of the reception of the packet i to the transmission-side device TX.

On the other hand, when the packet i has not yet been received (step S24; No), the processing proceeds to step S26. In step S26, the reception-side device RX determines whether or not the waiting time Tw has elapsed from the detection of the packet missing. When the waiting time Tw has not elapsed (step S26; No), the processing returns to step S24.

When the waiting time Tw has elapsed from the detection of the packet missing (step S26; Yes), the processing proceeds to step S27. In step S27, the reception-side device RX transmits the retransmission request related to the packet i to the transmission-side device TX.

### 3-4. First Modification

In the first modification, a difference in propagation time between the first communication route CR-1 and the second communication route CR-2 is considered. A propagation time T₁ along the first communication route CR-1 and a propagation time T₂ along the second communication route CR-2 are expressed by Formula (2) below.

T₁=T_{L}×N_{L1}+T_{S}×N_{S1}+T_{TX1}+T_{RX1}T₂=T_{L}×N_{L2}+T_{S}×N_{S2}+T_{TX2}+T_{RX2} Formula (2)

T_{L} is a propagation time in an inter-node station link. N_{L1} is the total number of inter-node station links with the propagation time T_{L} included in the first communication route CR-1. N_{L2} is the total number of inter-node station links with the propagation time T_{L} included in the second communication route CR-2. T_{S} is a processing time in the node station ND. N_{S1} is the total number of node stations ND with the processing time T_{S} included in the first communication route CR-1. N_{S2} is the total number of node stations ND with the processing time T_{S} included in the second communication route CR-2. T_{TX1} is a propagation time in a link between the transmission-side device TX and the node station ND of the first communication route CR-1. T_{TX2} is a propagation time in a link between the transmission-side device TX and the node station ND of the second communication route CR-2. Taxi is a propagation time in a link between the reception-side device RX and the node station ND of the first communication route CR-1. T_{RX2} is a propagation time in a link between the reception-side device RX and the node station ND of the second communication route CR-2.

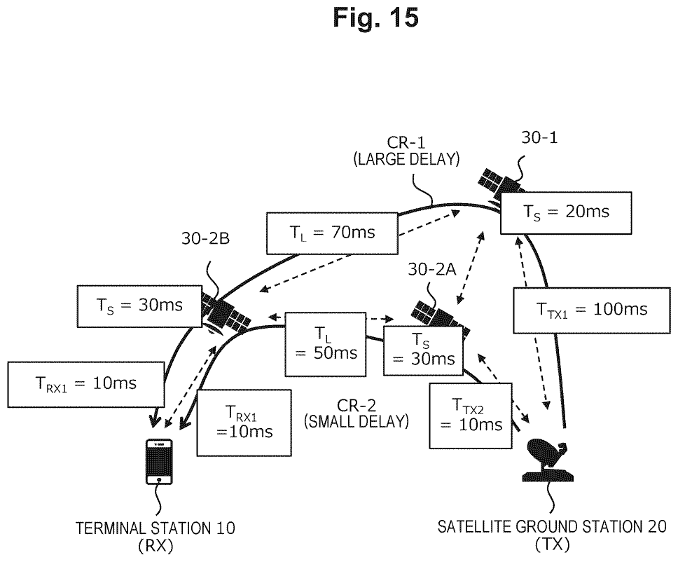

FIG. 15 illustrates an example of each propagation time. The propagation time T₁ along the first communication route CR-1 is 230 ms (=70 ms×1+20 ms×1+30 ms×1+100 ms+10 ms). The propagation time T₂ along the second communication route CR-2 is 130 ms (=50 ms×1+30 ms×2+10 ms+10 ms). A difference between the propagation time T₁ and the propagation time T₂ is 100 ms. Each value may be a predetermined value (fixed value) or a measurement value.

The waiting time Tw in the reception-side device RX is determined on the basis of a difference in propagation time between the first communication route CR-1 and the second communication route CR-2. For example, the waiting time Tw is set to a difference between the propagation times. The waiting time Tw may be determined by the reception-side device RX or may be determined by another device. In the latter case, the waiting time Tw determined by another device is provided to the reception-side device RX.

Similarly, the additional time RTOa in the transmission-side device TX is determined on the basis of a difference in propagation time between the first communication route CR-1 and the second communication route CR-2. For example, the additional time RTOa is set to a difference between the propagation times. The additional time RTOa may be determined by the transmission-side device TX or may be determined by another device. In the latter case, the additional time RTOa determined by another device is provided to the transmission-side device TX.

The waiting time Tw in the reception-side device RX and the additional time RTOa in the transmission-side device TX may be the same. In this case, the waiting time Tw and the additional time RTOa determined in any of the devices are shared by each of the devices requiring them.

According to the first modification, the waiting time Tw in the reception-side device RX and the additional time RTOa in the transmission-side device TX are set to appropriate values without excess or deficiency. This makes it possible to efficiently suppress a decrease in throughput of the entire system.

### 3-5. Second Modification

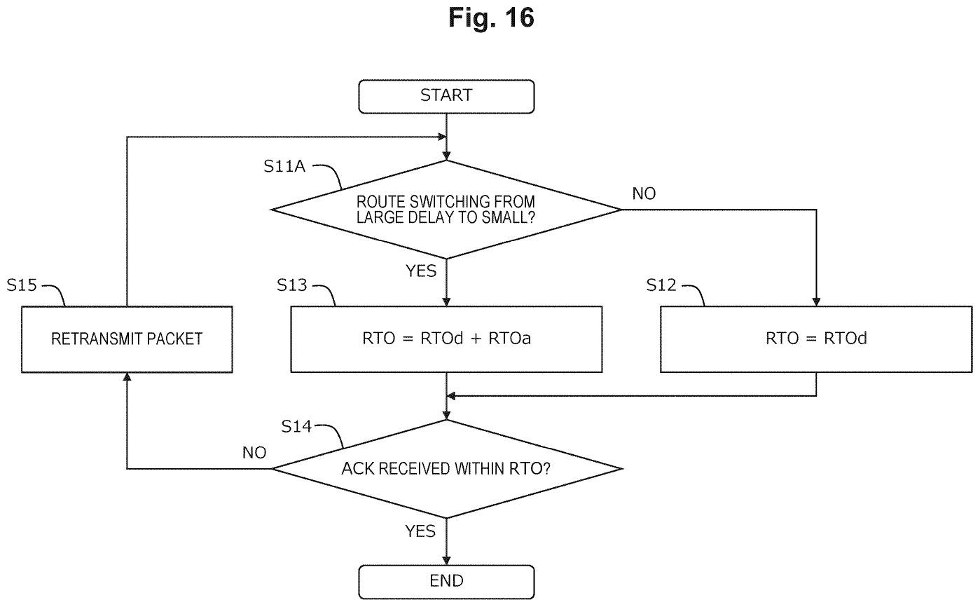

FIG. 16 is a flowchart illustrating a second modification of retransmission control in the transmission-side device TX. Step S11 in FIG. 13 described above is replaced with step S11A. The rest is similar to the case of FIG. 13.

In step S11A, the transmission-side device TX determines whether or not the packet i has been transmitted in the route switching time zone PSW in which the delay of the communication route CR is reduced. Whether or not the delay of the communication route CR is reduced, that is, whether or not the delay in the second communication route CR-2 is smaller than the delay in the first communication route CR-1 can be determined on the basis of the propagation times T₁ and T₂ described above. When the packet i is transmitted in the route switching time zone PSW in which the delay of the communication route CR is reduced (step S11A; Yes), the processing proceeds to step S13. Otherwise (step S11A; No), the processing proceeds to step S12.

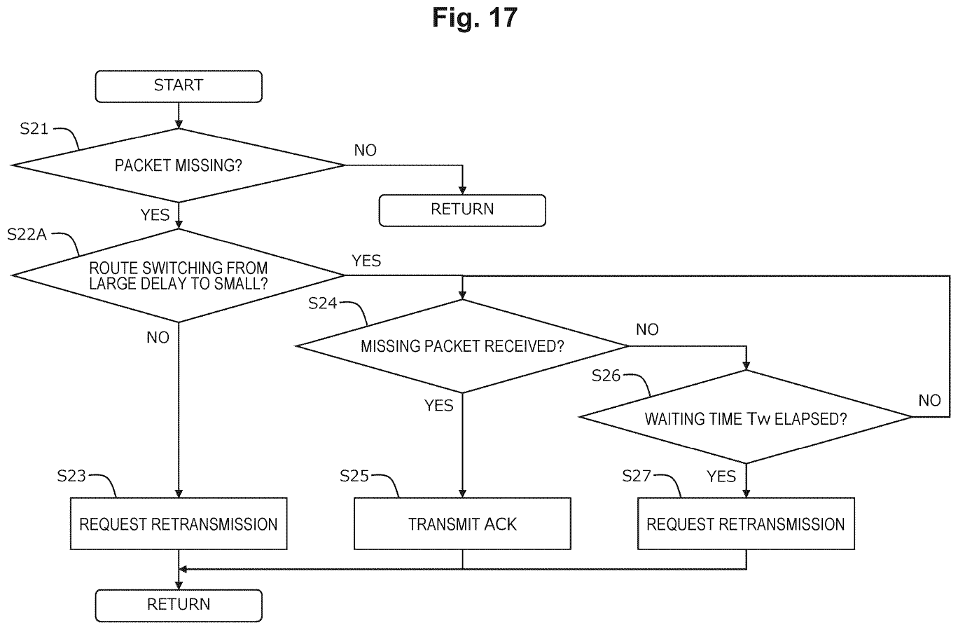

FIG. 17 is a flowchart illustrating a second modification of retransmission control in the reception-side device RX. Step S22 in FIG. 14 described above is replaced with step S22A. The rest is similar to the case of FIG. 14.

In step S22A, the reception-side device RX determines whether or not the packet missing has occurred in the route switching time zone PSW in which the delay of the communication route CR is reduced. Whether or not the delay of the communication route CR is reduced, that is, whether or not the delay in the second communication route CR-2 is smaller than the delay in the first communication route CR-1 can be determined on the basis of the propagation times T₁ and T₂ described above. When the packet missing occurs in the route switching time zone PSW in which the delay of the communication route CR is reduced (step S22A; Yes), the processing proceeds to step S24. Otherwise (step S22A; No), the processing proceeds to step S23.

### 4. Configuration Examples of Transmission-Side Device and Reception-Side Device

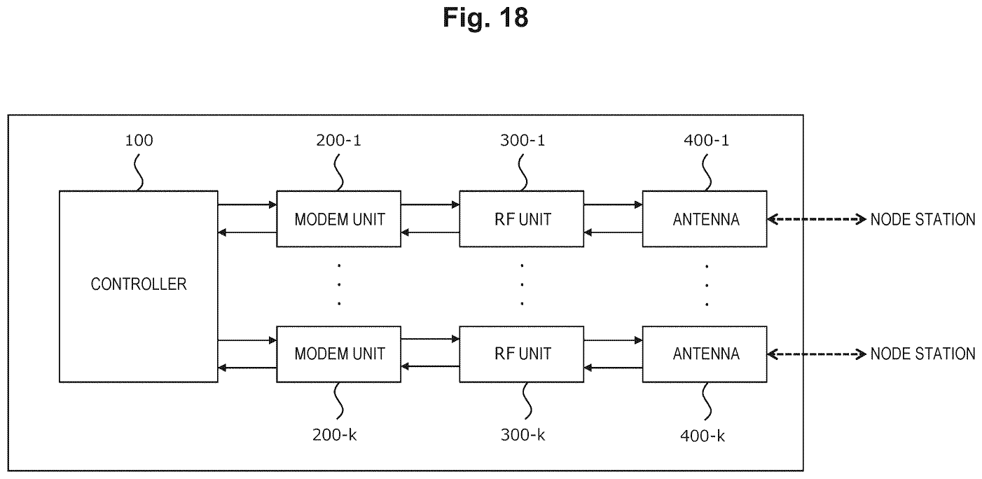

FIG. 18 is a block diagram illustrating a configuration example of each of the transmission-side device TX and the reception-side device RX according to the present embodiment. Each of the transmission-side device TX and the reception-side device RX includes a controller 100, one or more modem units 200-1 to 200-k, one or more RF units 300-1 to 300-k, and one or more antenna units 400-1 to 400-k. k is an integer of 1 or more.

The controller 100 outputs a transmission signal to the modem unit 200. The modem unit 200 modulates the transmission signal and outputs the modulated transmission signal to the RF unit 300. The RF unit 300 transmits a transmission signal via the antenna 400. Furthermore, the RF unit 300 receives a signal via the antenna 400 and outputs the received signal to the modem unit 200. The modem unit 200 demodulates the received signal and outputs the demodulated received signal to the controller 100.

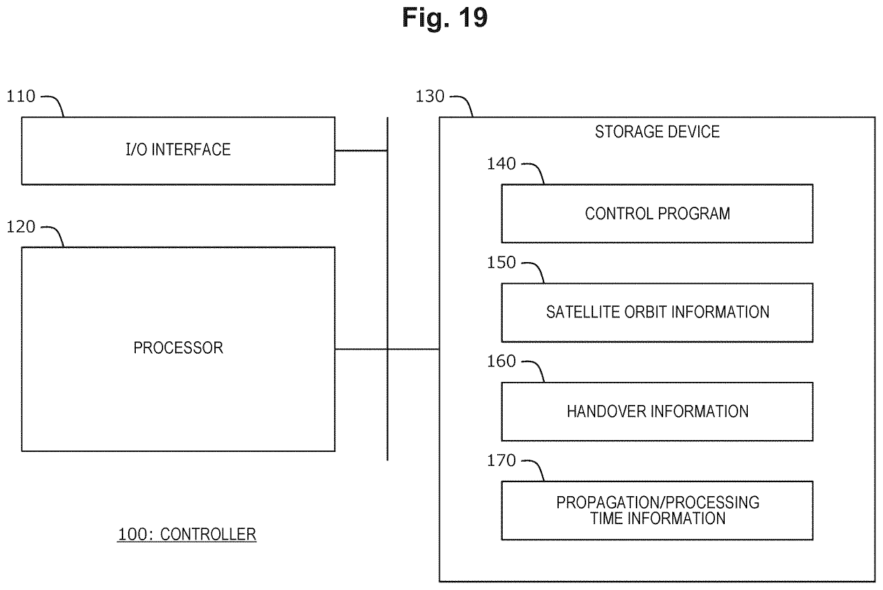

FIG. 19 is a block diagram illustrating a configuration example of the controller 100. The controller 100 includes an I/O interface 110, one or more processors 120 (hereinafter, simply referred to as a “processor 120”), and one or more storage devices 130 (hereinafter, simply referred to as a “storage device 130”).

The processor 120 performs various types of information processing. For example, the processor 120 includes a central processing unit (CPU). The processor 120 performs communication control on the basis of the TCP. For example, the processor 120 performs the above-described retransmission control.

The storage device 130 stores various types of information necessary for processing by the processor 120. Examples of the storage device 130 include a volatile memory, a nonvolatile memory, a hard disk drive (HDD), and a solid state drive (SSD).

A control program 140 is a computer program executed by the processor 120. The processor 120 executes the control program 140 to implement the functions of the controller 100 (processor 120). The control program 140 is stored in the storage device 130. The control program 140 may be recorded on a computer-readable recording medium. The control program 140 may be provided to the controller 100 via a network.

Satellite orbit information 150 is information regarding the orbit of each satellite relay station 30. The satellite orbit information 150 is provided from the satellite relay station 30 or the satellite management system. The processor 120 can predict the route switching timing on the basis of the satellite orbit information 150 of the satellite relay station 30, and grasp the route switching time zone PSW on the basis of the predicted route switching timing.

Handover information 160 is information regarding handover during communication. The handover information is acquired by the transmission-side device TX or the reception-side device RX. Alternatively, the handover information may be provided from a communication management system. The processor 120 can sense the route switching timing on the basis of the handover information and grasp the route switching time zone PSW on the basis of the sensed route switching timing.

Propagation/processing time information 170 is information indicating a propagation time and a processing time as illustrated in FIG. 15. Each value may be a predetermined value (fixed value) or a measurement value. For example, the propagation time is measured in each of the transmission-side device TX, the reception-side device RX, and the node station ND, and is shared by the devices. The processing time in each node station ND is provided from each node station ND. The processor 120 can execute the processing according to the first modification and the second modification described above on the basis of the propagation/processing time information 170.

The controller 100 may be implemented with the use of hardware such as an application specific integrated circuit (ASIC), a programmable logic device (PLD), or a field programmable gate array (FPGA).

### REFERENCE SIGNS LIST

1 Communication system
10 Terminal station
20 Satellite ground station
30 Satellite relay station
40 Cellular base station
100 Controller
110 I/O interface
120 Processor
130 Storage device
140 Control program
150 Satellite orbit information
160 Handover information
170 Propagation/processing time information
CR Communication route
CR-1 First communication route
CR-2 Second communication route
ND Node station
PSW Route switching time zone
RTO Retransmission timeout
RTOa Additional time
RTOd Default value
RX Reception-side device
TX Transmission-side device
Tw Waiting time

1. A communication system that performs communication on a basis of a transmission control protocol (TCP), the communication system comprising:
a transmitter at a transmission-side; and
a receiver at a reception-side,
wherein:
a route switching time zone is a time zone in which a communication route between the transmitter and the receiver is switched from a first communication route to a second communication route, and
the receiver includes circuitry configured to:
prohibit transmission of a retransmission request related to a first packet to the transmitter during a first time from detection of packet missing when the packet missing of the first packet is detected in the route switching time zone, and
transmit the retransmission request related to the first packet to the transmitter when the first packet is not received during the first time.

2. The communication system according to claim 1, wherein:
the first time is determined on a basis of a difference in propagation time between the first communication route and the second communication route.

3. The communication system according to claim 1, wherein:
the transmitter sets a retransmission timeout to be longer than a default value by a second time regarding a second packet transmitted to the receiver in the route switching time zone.

4. The communication system according to claim 3, wherein:
the second time is determined on a basis of a difference in propagation time between the first communication route and the second communication route.

5. The communication system according to claim 1, wherein:
a delay in the second communication route is smaller than a delay in the first communication route.

6. A retransmission control method in a communication system that performs communication between a transmitter at a transmission-side and a receiver at a reception-side on a basis of a transmission control protocol (TCP), wherein:
a route switching time zone is a time zone in which a communication route between the transmitter and the receiver is switched from a first communication route to a second communication route,
the retransmission control method comprising:
processing of prohibiting transmission of a retransmission request related to a first packet from the receiver to the transmitter during a first time from detection of packet missing when the packet missing of the first packet is detected by the receiver in the route switching time zone; and
processing of transmitting the retransmission request related to the first packet from the receiver to the transmitter when the receiver does not receive the first packet during the first time.

7. A reception-side device that performs communication with a transmitter at a transmission-side on a basis of a transmission control protocol (TCP), the reception-side device comprising:
circuitry configured to perform retransmission control, wherein:
a route switching time zone is a time zone in which a communication route between the transmitter and the reception-side device is switched from a first communication route to a second communication route, and
the circuitry is further configured to:
prohibit transmission of a retransmission request related to a first packet to the transmitter during a first time from detection of packet missing when the packet missing of the first packet is detected in the route switching time zone, and
transmit the retransmission request related to the first packet to the transmitter when the first packet is not received during the first time.

8. (canceled)
